(19) United States
(12) Patent Application Publication
(10) Pub. No.: US 2024/0283120 A1
(43) Pub. Date: Aug. 22, 2024

(54) ISOLATOR AND IMPLEMENTATION METHOD THEREFOR

(71) Applicant: ZHEJIANG DONGYANG DONGCI CHENGJI ELECTRONICS CO. , LTD., Jinhua (CN)

(72) Inventors: Fuhai XIAO, Jinhua (CN); Xiaodan SUN, Jinhua (CN)

(21) Appl. No.: 18/569,078

(22) PCT Filed: Sep. 6, 2021
(86) PCT No.: PCT/CN2021/116631

§ 371 Date: Dec. 11, 2023

(30) Foreign Application Priority Data
Jun. 11, 2021 (CN) 202110654809.6

(51) Int. Cl. H01P 1/36; H01P 11/00

(52) U.S. Cl. CPC H01P 1/362; H01P 11/00

(57) ABSTRACT

An isolator includes a casing. An interior of the casing includes a positioning ring, a lower permanent magnet, a lower uniform magnetic sheet, a lower ferrite, a central conductor, an upper ferrite, a six-foot uniform magnetic sheet, an upper permanent magnet, a temperature compensation sheet and an upper uniform magnetic sheet in sequence from bottom to top. A cover plate is connected to the top of the casing. The central conductor comprises three central junctions forming an angle of 120 degrees with each other, and each having a longitudinal slit along a center line thereof, and first and second transverse slits respectively intersecting with the longitudinal slit, the second transverse slit being located outside of the first transverse slit. A method is disclosed for implementing the isolator, which increases internal magnetic field intensity, reduces third-order inter-modulation, and improves signal quality.

This application is a U.S. national phase application of a PCT Application No. PCT/CN2021/116631 filed on Sep. 6, 2021, which claims a priority to Chinese Patent Application No. 202110654809.6 filed on Jun. 11, 2021, the disclosures of which are incorporated in their entirety by reference herein.

### FIELD OF THE INVENTION

The present invention belongs to the technical field of isolators, and specifically relates to an isolator and an implementation method therefor.

### BACKGROUND OF THE INVENTION

With the rapid development of the information age, high-frequency communication devices such as mobile phones and communication base stations have become people's demand. Moreover, with the application of technology in the 5G era, people have higher requirements for miniaturization, low cost and performance stability of hardware devices. The components such as circulators and isolators applied to the devices are also designed to increasingly fulfill the requirements for miniaturization, low cost and performance stability.

In the high magnetic field and wide operating frequency band, low insertion loss and low third-order inter-modulation have become prominent and important indicators of current isolators or circulators.

Therefore, there is an urgent need for an isolator or circulator that reduces insertion loss and third-order inter-modulation as well as improves signal quality.

### SUMMARY OF THE INVENTION

An object of the present invention is to provide an isolator, so as to solve the problems raised in the above “background of the invention”. The present invention provides an isolator, which is characterized by reducing insertion loss and third-order inter-modulation of the circulator or isolator and improving communication signal quality.

The other object of the present invention is to provide a method for implementing the isolator.

In order to achieve the above objects, the present invention provides the following technical solution: An isolator is provided, comprising a casing; the interior of the casing is provided with a positioning ring, a lower permanent magnet, a lower uniform magnetic sheet, a lower ferrite, a central conductor, an upper ferrite, a six-foot uniform magnetic sheet, an upper permanent magnet, a temperature compensation sheet and an upper uniform magnetic sheet in sequence from bottom to top; and a cover plate is connected to the top of the casing.

Further, in the present invention, in order to increase internal magnetic field intensity, reduce third-order inter-modulation and improve signal quality, the central conductor comprises three central junctions forming an angle of 120 degrees with each other; each of the central junctions is provided with a longitudinal slit along the center line thereof, and further provided with a first transverse slit and a second transverse slit respectively intersecting with the longitudinal slit, the second transverse slit being located outside of the first transverse slit; the first transverse slit, the second transverse slit and the longitudinal slit all have a width of 0.1-1.0 mm; the first transverse slit and the second transverse slit are circular arc structures concentric with the circular arc outer edge of the central junction; and the central conductor is a sheet structure of oxygen-free copper or phosphorus copper.

Further, in the present invention, in order to increase inductive reactance and thus achieve impedance matching, the central conductor further comprises central-junction branches connected to the center of the three central junctions and forming an angle of 120 degrees with each other; a central-junction-branch extension foot is connected to each central-junction branch, and an included angle is formed between the central-junction branch and the central-junction-branch extension foot; and a through hole is provided in the central-junction-branch extension foot, with a metal terminal connected in the through hole.

Further, in the present invention, in order to reduce the number of components that the circuit passes through and reduce insertion loss, the six-foot uniform magnetic sheet is provided on the circumference thereof with six extension feet in a circular array, and the casing is provided with three grooves in a circular array, with the extension feet welded to groove walls of the corresponding grooves.

Further, in the present invention, the method for implementing the isolator comprises the following steps:

(1) placing the positioning ring, the lower permanent magnet, the lower uniform magnetic sheet and the lower ferrite into the casing in sequence;

(2) welding the three metal terminals to the central-junction-branch extension feet, respectively, and then placing the central conductor into the casing, so that the three central-junction-branch extension feet are respectively located in the grooves of the casing;

(3) placing the upper ferrite, the six-foot uniform magnetic sheet, the upper permanent magnet, the temperature compensation sheet and the upper uniform magnetic sheet into the casing in sequence;

(4) placing the cover plate on the top of the casing so that the posts at the top of the casing pass through the notches of the cover plate, and then bending the posts to complete the assembly; and

(5) welding the six extension feet to groove walls of the corresponding grooves, respectively.

The present invention has the following beneficial effects compared with the prior art:

1. In the present invention, a part of a coupled circuit is added to an oscillation circuit in the central junction, which increases internal magnetic field intensity, reduces third-order inter-modulation, and improves signal quality;

2. in the present invention, the wider the first transverse slit, the second transverse slit and the longitudinal slit, the more significant the increase in the internal magnetic field intensity;

3. in the present invention, each central-junction branch forms an unequal angle with its adjacent two central junctions, which solves the problem that the first transverse slit, the second transverse slit, and the longitudinal slit provided on the central junction increase internal magnetic field intensity but cause reduced inductive reactance and impedance mismatching;

4. in the present invention, the included angle between the central-junction branch and the central-junction-branch extension foot increases the length of the circuit, which increases inductive reactance and thus achieves impedance matching without changing the width of the central junction; and

5. in the present invention, the six-foot uniform magnetic sheet is provided on the circumference thereof with six extension feet in a circular array, and the extension feet are welded to groove walls of the corresponding grooves, so that one branch of the oscillation circuit, after passing through the central conductor, only needs to pass through the ferrite to reach the six-foot uniform magnetic sheet; because the six-foot uniform magnetic sheet is welded to the casing, it is equivalent to direct grounding, thereby reducing the number of components that the circuit passes through; since the more components that the circuit passes through, the cumulatively greater the loss generated, this application significantly reduces insertion loss.

### BRIEF DESCRIPTION OF THE DRAWINGS

FIG. 1 is an exploded schematic diagram of the structure of the present invention;

FIG. 2 is a schematic diagram of the structure of the six-foot uniform magnetic sheet of the present invention.

FIG. 3 is a schematic diagram of the structure of the casing of the present invention;

FIG. 4 is a schematic diagram of the overall structure of the present invention;

FIG. 5 is a schematic diagram of the structure of the central conductor of the present invention; and

FIG. 6 shows a comparison of third-order inter-modulation between the present invention and the prior art.

In the figures: 1. cover plate; 2. upper uniform magnetic sheet; 3. temperature compensation sheet; 4. upper permanent magnet; 5. six-foot uniform magnetic sheet; 51. extension foot; 6. upper ferrite; 7. central conductor; 71. central junction; 711. first transverse slit; 712. second transverse slit; 713. longitudinal slit; 72. central-junction branch; 73. central-junction-branch extension foot; 8. lower ferrite; 9. lower uniform magnetic sheet; 10. lower permanent magnet; 11. positioning ring; 12. casing; 121. groove wall; and 13. metal terminal.

### DETAILED DESCRIPTION OF THE EMBODIMENTS

The technical solution in the examples of the present invention will be clearly and completely described below with reference to the accompanying drawings in the examples of the present invention. Obviously, the described examples are only part, rather than all, of the examples of the present invention. Any other examples obtained by those of ordinary skill in the art according to the examples of the present invention without creative efforts shall fall within the scope of protection of the present invention.

### Example 1

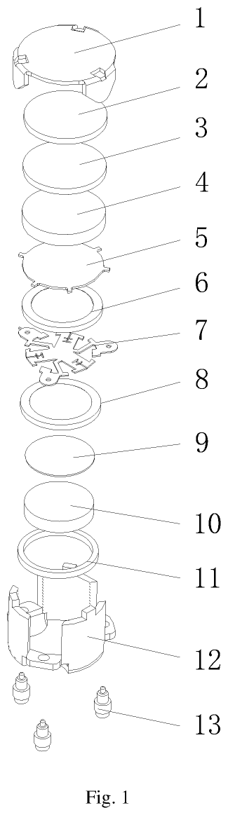

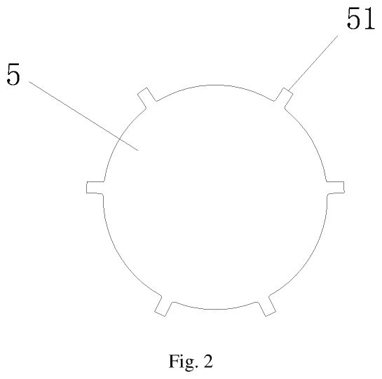

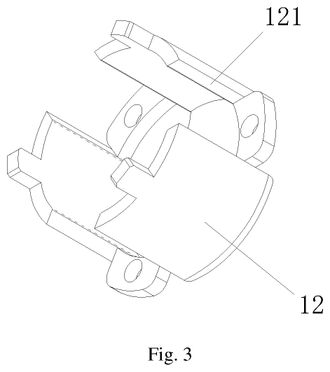

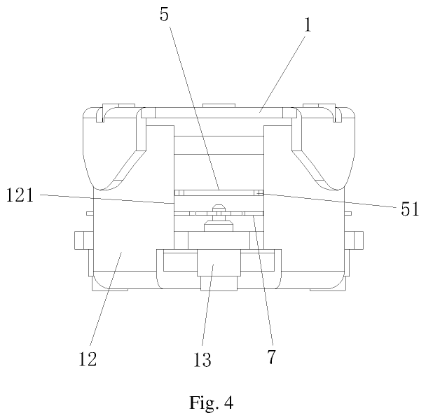

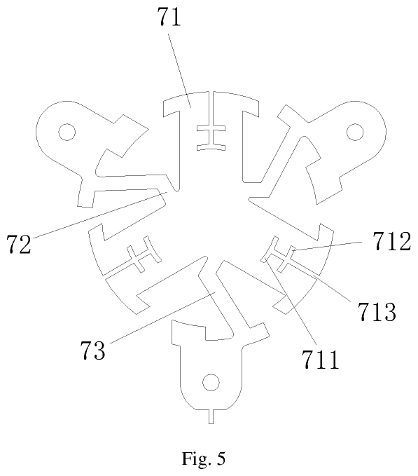

With reference to FIGS. 1-6, the present invention provides the following technical solution: An isolator is provided, comprising a casing 12; the interior of the casing 12 is provided with a positioning ring 11, a lower permanent magnet 10, a lower uniform magnetic sheet 9, a lower ferrite 8, a central conductor 7, an upper ferrite 6, a six-foot uniform magnetic sheet 5, an upper permanent magnet 4, a temperature compensation sheet 3 and an upper uniform magnetic sheet 2 in sequence from bottom to top; and a cover plate 1 is connected to the top of the casing 12.

Specifically, the central conductor 7 comprises three central junctions 71 forming an angle of 120 degrees with each other; each of the central junctions 71 is provided with a longitudinal slit 713 along the center line thereof, and further provided with a first transverse slit 711 and a second transverse slit 712 respectively intersecting with the longitudinal slit 713, the second transverse slit 712 being located outside of the first transverse slit 711; the first transverse slit 711, the second transverse slit 712 and the longitudinal slit 713 all have a width of 0.1-1.0 mm; the first transverse slit 711 and the second transverse slit 712 are circular arc structures concentric with the circular arc outer edge of the central junction 71; and the central conductor 7 is a sheet structure of oxygen-free copper or phosphorus copper.

With the above technical solution, a part of a coupled circuit is added to an oscillation circuit in the central junction 71, which increases internal magnetic field intensity, reduces third-order inter-modulation, and improves signal quality; the wider the first transverse slit 711, the second transverse slit 712 and the longitudinal slit 713, the more significant the increase in the internal magnetic field intensity, the width in this example preferably being 0.5 mm.

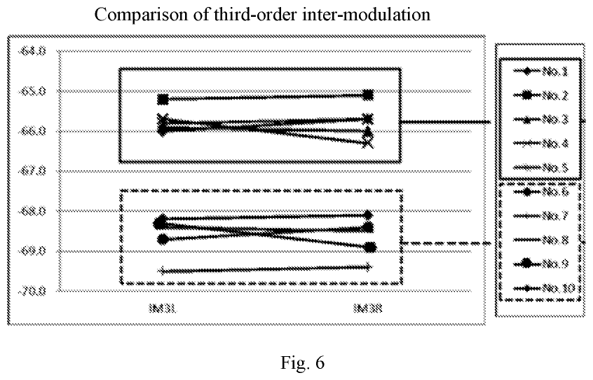

As shown in FIG. 6, the third-order inter-modulation data of five circulator products of the prior art are shown in the solid-line rectangular box, and the third-order inter-modulation data of five circulator products of the present invention are shown in the dashed-line rectangular box. As is apparent from FIG. 6, the present invention significantly reduces third-order inter-modulation compared with the prior-art circulator products.

### Example 2

The difference between this example and Example 1 is as follows: Specifically, the central conductor 7 further comprises central-junction branches 72 connected to the center of the three central junctions 71 and forming an angle of 120 degrees with each other; a central-junction-branch extension foot 73 is connected to each central-junction branch 72, and an included angle is formed between the central-junction branch 72 and the central-junction-branch extension foot 73, the included angle being 0-180 degrees, preferably 120 degrees in this example; and a through hole is provided in the central-junction-branch extension foot 73, with a metal terminal 13 connected in the through hole.

With the above technical solution, each central-junction branch 72 forms an unequal angle with its adjacent two central junctions 71, which solves the problem that the first transverse slit 711, the second transverse slit 712, and the longitudinal slit 713 provided on the central junction 71 increase internal magnetic field intensity but cause reduced inductive reactance and impedance mismatching.

Besides, the included angle between the central-junction branch 72 and the central-junction-branch extension foot 73 increases the length of the circuit, which increases inductive reactance and thus achieves impedance matching without changing the width of the central junction 71.

### Example 3

The difference between this example and Example 1 is as follows: Specifically, the six-foot uniform magnetic sheet 5 is provided on the circumference thereof with six extension feet 51 in a circular array, and the casing 12 is provided with three grooves in a circular array, with the extension feet 51 welded to groove walls 121 of the corresponding grooves.

With the above technical solution, one branch of the oscillation circuit, after passing through the central conductor 7, only needs to pass through the ferrite to reach the six-foot uniform magnetic sheet 5; because the six-foot uniform magnetic sheet 5 is welded to the casing 12, it is equivalent to direct grounding, thereby reducing the number of components that the circuit passes through; since the more components that the circuit passes through, the cumulatively greater the loss generated, this application significantly reduces insertion loss.

Further, the method of the present invention for implementing the isolator comprises the following steps:

(1) placing the positioning ring 11, the lower permanent magnet 10, the lower uniform magnetic sheet 9 and the lower ferrite 8 into the casing 12 in sequence;

(2) welding the three metal terminals 13 to the central-junction-branch extension feet 73, respectively, and then placing the central conductor 7 into the casing 12, so that the three central-junction-branch extension feet 73 are respectively located in the grooves of the casing 12;

(3) placing the upper ferrite 6, the six-foot uniform magnetic sheet 5, the upper permanent magnet 4, the temperature compensation sheet 3 and the upper uniform magnetic sheet 2 into the casing 12 in sequence;

(4) placing the cover plate 1 on the top of the casing 12 so that the posts at the top of the casing 12 pass through the notches of the cover plate 1, and then bending the posts to complete the assembly; and

(5) welding the six extension feet 51 to groove walls 121 of the corresponding grooves, respectively.

To sum up, in the present invention, a part of a coupled circuit is added to an oscillation circuit in the central junction 71, which increases internal magnetic field intensity, reduces third-order inter-modulation, and improves signal quality; in the present invention, the wider the first transverse slit 711, the second transverse slit 712 and the longitudinal slit 713, the more significant the increase in the internal magnetic field intensity; in the present invention, each central-junction branch 72 forms an unequal angle with its adjacent two central junctions 71, which solves the problem that the first transverse slit 711, the second transverse slit 712, and the longitudinal slit 713 provided on the central junction 71 increase internal magnetic field intensity but cause reduced inductive reactance and impedance mismatching; in the present invention, the included angle between the central-junction branch 72 and the central-junction-branch extension foot 73 increases the length of the circuit, which increases inductive reactance and thus achieves impedance matching without changing the width of the central junction 71; in the present invention, the six-foot uniform magnetic sheet 5 is provided on the circumference thereof with six extension feet 51 in a circular array, and the extension feet 51 are welded to groove walls 121 of the corresponding grooves, so that one branch of the oscillation circuit, after passing through the central conductor 7, only needs to pass through the ferrite to reach the six-foot uniform magnetic sheet 5; because the six-foot uniform magnetic sheet 5 is welded to the casing 12, it is equivalent to direct grounding, thereby reducing the number of components that the circuit passes through; since the more components that the circuit passes through, the cumulatively greater the loss generated, this application significantly reduces insertion loss.

Although the examples of the present invention have been shown and described, it is understood by those of ordinary skill in the art that various changes, modifications, substitutions and variations can be made to these examples without departing from the principle and spirit of the present invention, and the scope of the present invention is defined by the appended claims and their equivalents.

1. An isolator, comprising a casing, characterized in that: an interior of the casing is provided with a positioning ring, a lower permanent magnet, a lower uniform magnetic sheet, a lower ferrite, a central conductor, an upper ferrite, a six-foot uniform magnetic sheet, an upper permanent magnet, a temperature compensation sheet and an upper uniform magnetic sheet in sequence from bottom to top, and a cover plate is connected to a top of the casing; wherein the central conductor comprises three central junctions forming an angle of 120 degrees with each other; each of the central junctions is provided with a longitudinal slit along a center line thereof, and further provided with a first transverse slit and a second transverse slit respectively intersecting with the longitudinal slit, the second transverse slit being located outside of the first transverse slit.

2. The isolator according to claim 1, characterized in that: the first transverse slit, the second transverse slit and the longitudinal slit all have a width of 0.1-1.0 mm.

3. The isolator according to claim 1, characterized in that: the first transverse slit and the second transverse slit are circular arc structures concentric with a circular arc outer edge of the central junction.

4. The isolator according to claim 1, characterized in that: the central conductor is a sheet structure of oxygen-free copper or phosphorus copper.

5. The isolator according to claim 1, characterized in that: the central conductor further comprises central-junction branches connected to a center of the three central junctions and forming an angle of 120 degrees with each other.

6. The isolator according to claim 5, characterized in that: a central-junction-branch extension foot is connected to each central-junction branch, and an included angle is formed between the central-junction branch and the central-junction-branch extension foot.

7. The isolator according to claim 6, characterized in that: a through hole is provided in the central-junction-branch extension foot, with a metal terminal connected in the through hole.

8. The isolator according to claim 1, characterized in that: the six-foot uniform magnetic sheet is provided on a circumference thereof with six extension feet in a circular array.

9. The isolator according to claim 8, characterized in that: the casing is provided with three grooves in a circular array, and the extension feet are welded to groove walls of the corresponding grooves.

10. A method for implementing the isolator according to claim 1, characterized in that: the method comprises the following steps:
placing the positioning ring, the lower permanent magnet, the lower uniform magnetic sheet and the lower ferrite into the casing in sequence;
welding the three metal terminals to the central-junction-branch extension feet, respectively, and then placing the central conductor into the casing, so that the three central-junction-branch extension feet are respectively located in the grooves of the casing;
placing the upper ferrite, the six-foot uniform magnetic sheet, the upper permanent magnet, the temperature compensation sheet and the upper uniform magnetic sheet into the casing in sequence;
placing the cover plate on the top of the casing so that posts at the top of the casing pass through notches of the cover plate, and then bending the posts to complete the assembly; and
welding the six extension feet to groove walls of the corresponding grooves, respectively.
